(19) United States
(12) Patent Application Publication
(10) Pub. No.: US 2007/0225388 A1
(43) Pub. Date: Sep. 27, 2007

(54) Porous Bodies and Method of Production Thereof

(76) Inventors: Andrew Ian Cooper, Liverpool (GB); Alison Jayne Foster, Bebington (GB); Steven Paul Rannard, Bebington (GB); Haifei Zhang, Liverpool (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/587,734

(22) PCT Filed: Dec. 23, 2004
(86) PCT No.: PCT/EP04/14777

§ 371 Date: May 17, 2007

(30) Foreign Application Priority Data
Jan. 28, 2004 (GB) 0401950.1

(51) Int. Cl. C08J 9/28; C08J 9/16

(52) U.S. Cl. 521/64; 521/141; 521/189; 521/50

(57) ABSTRACT

Water dispersible or water soluble porous bodies comprising a three dimensional open-cell lattice containing (a) 10 to 95% by weight of a water soluble polymeric material and (b) 5 to 90% by weight of a surfactant, said porous bodies having an intrusion volume as measured by mercury porosimetry of at least about 3 ml/g with the proviso that said porous bodies are not spherical beads having an average bead diameter of 0.2 to 5 mm

The present invention relates to water soluble or water dispersible porous bodies and to methods of producing such porous bodies.

Copending international patent application PCT/GB03/03226 (assigned to the present applicants) describes the formation of porous beads comprising a three dimensional open-cell lattice of a water-soluble polymeric material with an average bead diameter in the range 0.2 to 5 mm.

It is an object of the present invention to provide highly porous bodies which disperse rapidly when contacted with water. It is a further object of the invention to provide a simple and effective method for producing such porous bodies.

In accordance with a first aspect of the invention, there is provided water dispersible or water soluble porous bodies comprising a three dimensional open-cell lattice containing

(a) 10 to 95% by weight of a water soluble polymeric material and

(b) 5 to 90% by weight of a surfactant,

said porous bodies having an intrusion volume as measured by mercury porosimetry (as hereinafter described) of at least about 3 ml/g

with the proviso that said porous bodies are not spherical beads having an average bead diameter of 0.2 to 5 mm

Preferably the porous bodies of the present invention contain 10 to 80% by weight of the water soluble polymeric material and 20 to 90% by weight of the surfactant. More preferably the porous bodies of the present invention contain 20 to 70% by weight of the water soluble polymeric material and 30 to 80% by weight of the surfactant.

The polymeric material is a material which would be considered as “water soluble” by those skilled in the art i.e. if it forms a homogeneous solution in water. In general terms water soluble polymers possess pendant polar or ionizable groups (e.g. —C═O, —OH, —N(R₁)(R₂) in which R₁ and R₂, which may be the same or different, are independently H or (C1 to C4)alkyl, —N(R₃)(R₄)(R₅)⁺ in which R_{3,} R₄ and R₅ which may be the same or different, are independently H or (C1 to C4)alkyl, —CON(R₆)(R₇) in which R6 and R7, which may be the same or different, are H or (C1 to C4) alkyl, —CH₂CH₂O—, —CO₂H or salts thereof, —SO₃H or salts thereof groups) on a backbone chain which may be hydrophobic.

It is also important for the operation of the present invention that the porous bodies dissolve or disperse quickly so that the materials contained within the lattice are dispersed quickly when the porous bodies are exposed to an aqueous medium. It has been found that when water soluble polymeric materials are incorporated into the porous bodies of the present invention, the time it takes for the polymeric material to dissolve or disperse may be significantly reduced. The nature of the lattice should be such that the dissolution or dispersion of the porous bodies preferably occurs in less than three minutes, more preferably less than two minutes, most preferably less than one minute.

Examples of water soluble polymeric materials include:—

(a) natural polymers (for example naturally occurring gums such as guar gum or locust bean gum or a polysaccharide such as dextran or cellulose;

(b) cellulose derivatives for example xanthan gum, xyloglucan, cellulose acetate, methylcellulose, methyethylcellulose, hydroxyethylcellulose, hydroxyethylmethylcellulose, hydroxypropylcellulose, hydroxypropylmethylcellulose (HPMC), hydroxypropylbutylcellulose, ethylhydroxyethylcellulose, carboxymethylcellulose and its salts (eg the sodium salt—SCMC), or carboxymethylhydroxyethylcellulose and its salts (for example the sodium salt);

(c) homopolymers of any one of the monomers listed in Table 1 below;

d) copolymers prepared from two or more monomers listed in Table 1 below;

(e) mixtures thereof

TABLE 1

vinyl alcohol,
acrylic acid,
methacrylic acid
acrylamide,
methacrylamide
acrylamide methylpropane sulphonates
aminoalkylacrylates
aminoalkylmethacrylates
hydroxyethylacrylate
hydroxyethylmethylacrylate
vinyl pyrrolidone
vinyl imidazole
vinyl amines
vinyl pyridine
ethyleneglycol
ethylene oxide
ethyleneimine
styrenesulphonates
ethyleneglycolacrylates
ethyleneglycol methacrylate

When the polymeric material is a copolymer it may be a statistical copolymer (heretofore also known as a random copolymer), a block copolymer, a graft copolymer or a hyperbranched copolymer. Comonomers other than those listed in Table 1 may also be included in addition to those listed if their presence does not destroy the water soluble or water dispersible nature of the resulting polymeric material.

Examples of suitable homopolymers include polyvinylalcohol, polyacrylic acid, polymethacrylic acid, polyacrylamides (such as poly-N-isopropylacrylamide), polymethacrylamide; polyacrylamines, polymethylacrylamines, (such as polydimethylamino-ethylmethacrylate and poly-N-morpholinoethylmethacrylate, polyvinylpyrrolidone, polyvinylimidazole, polyvinylpyridine, polyethyleneimine and ethoxylated derivatives thereof.

The surfactant may be non-ionic, anionic, cationic, or zwitterionic and is preferably solid at ambient temperature. Examples of suitable non-ionic surfactants include ethoxylated triglycerides; fatty alcohol ethoxylates; alkylphenol ethoxylates; fatty acid ethoxylates; fatty amide ethoxylates; fatty amine ethoxylates; sorbitan alkanoates; ethylated sorbitan alkanoates; alkyl ethoxylates; pluronics; alkyl polyglucosides; stearol ethoxylates; alkyl polyglycosides. Examples of suitable anionic surfactants include alkylether sulfates; alkylether carboxylates; alkylbenzene sulfonates; alkylether phosphates; dialkyl sulfosuccinates; alkyl sulfonates; soaps; alkyl sulfates; alkyl carboxylates; alkyl phosphates; paraffin sulfonates; secondary n-alkane sulfonates; alpha-olefin sulfonates; isethionate sulfonates. Examples of suitable cationic surfactants include fatty amine salts; fatty diamine salts; quaternary ammonium compounds; phosphonium surfactants; sulfonium surfactants; sulfonxonium surfactants. Examples of suitable zwifterionic surfactants include N-alkyl derivatives of amino acids (such as glycine, betaine, aminopropionic acid); imidazoline surfactants; amine oxides; amidobetaines. Mixtures of surfactants may be used.

The bulk density of the porous polymeric bodies is preferably in the range of from about 0.01 to about 0.2 g/cm³, more preferably from about 0.02 to about 0.09 g/cm³, and most preferably from about 0.03 to about 0.08 g/cm³.

The porous bodies of the present invention may be formed by freezing an intimate mixture (for example an emulsion) of the polymeric material and the surfactant in a liquid medium and freeze drying the resulting frozen mixture.

The porous bodies of the present invention disperse when exposed to an aqueous medium. By including a water soluble polymeric material and a surfactant in the lattice of the porous bodies, porous bodies are formed which dissolve or disperse rapidly in aqueous media. The polymeric material, surfactant and any other components carried in the porous bodies will therefore become dispersed/dissolved when the bodies are exposed to an aqueous medium. The provision of the porous bodies of the present invention facilitates the dissolution or dispersion of the materials contained in the porous bodies and the dissolution/dispersion is more rapid than is observed when the same materials are used but are not in the porous bodies of the present invention. The porous bodies of the present invention may therefore be used to facilitate the dissolution or dispersion of polymeric materials or surfactants. For example, surfactants may be incorporated into porous bodies of the present invention which will disperse at lower temperatures and/or more easily than possible up to now. This is particularly beneficial when the surfactant is being used for delicate cleaning tasks such as for cleaning delicate fabrics or where only cold water is available for use in the cleaning process.

The present invention also includes, in a further aspect, solutions or dispersions comprising water soluble polymeric materials and surfactant formed by exposing the porous bodies of the present invention to an aqueous medium.

The porous bodies of the present invention may include within the lattice hydrophobic materials which will be dispersed when the polymeric bodies are dispersed in an aqueous medium. The hydrophobic materials may be incorporated into the lattice by dissolving them in the discontinuous oil phase of an oil-in-water emulsion from which the lattice is made. It has been found that the dispersion into an aqueous medium of hydrophobic materials contained within the porous bodies of the present invention is much improved when the porous bodies are exposed to the aqueous medium.

The present invention also includes, in a further aspect, solutions or dispersions comprising water soluble polymeric materials, surfactant and a hydrophobic material formed by exposing the porous bodies of the present invention having the hydrophobic material contained therein to an aqueous medium.

There are many instances in personal care products such as deodorants, skin and hair cleaning or care products or in household products such as laundry cleaning and care products or household cleaning or care products for hard and soft surfaces where it is desirable to administer hydrophobic materials in an aqueous environment. Because of the hydrophobic nature of these materials they are often reluctant to disperse in an aqueous environment. The use of the porous bodies of the present invention facilitates this dispersion and in many cases enables hydrophobic materials to be dispersed more effectively than previously.

It may be required to disperse the hydrophobic materials at the point where the product is being used. In this case the porous bodies of the present invention will be contained in the product until it is used by exposing it to an aqueous environment, at which time the water-soluble/dispersible lattice of the porous body will break down releasing the hydrophobic material.

The porous bodies of the present invention may be used to introduce hydrophobic materials into products, for example, liquid products during the manufacture of the products. In this case the lattice of the porous bodies of the present invention will break down when the porous bodies contact an aqueous environment during manufacture releasing the hydrophobic material in a form in which it can be more readily incorporated into the product being manufactured.

The porous bodies of the present invention may be used to transport materials to sites where they can be incorporated into products. By converting liquid products into porous bodies the need to transport large amounts of liquids can be avoided resulting in significant cost savings and safer transport of materials which are potentially hazardous when transported in a liquid form. Materials which would be potentially unstable if stored or transported in liquid form may be incorporated into the porous bodies of the present invention and stored or transported with less risk of degradation.

The incorporation of potentially unstable hydrophobic materials, for example vaccines, vitamins or perfumes, into the porous bodies of the present invention may protect them from degradation during storage prior to use.

Some specific examples of products in which the porous bodies of the present invention may be used are given below. These are given as examples only and are not intended to limit the applicability of the present invention. Those skilled in the art will however realise that the porous bodies of the present invention will have utility in other areas not specifically exemplified herein.

Hydrophobic materials that are released from the porous bodies of the present invention at the time of use may include:—
antimicrobial agents, for example: triclosan, climbazole, octapyrox, ketoconizole, phthalimoperoxyhexanoic acid (PAP), quaternary ammonium compounds, colloidal silver, zinc oxide.
antidandruff agent for example: zinc pyrithione
skin lightening agents for example 4-ethylresorcinol
fluorescing agents for example: 2,5-bis(2-benzoxazolyl) thiophene for use on fabrics (such as cotton, nylon, polycotton or polyester)in laundry products
skin conditioning agents, for example cholesterol
antifoaming agents for example isoparrafin
hair conditioning agents for example quaternary ammonium compounds, protein hydrolysates, peptides, ceramides and hydrophobic conditioning oils for example hydrocarbon oils such as paraffin oils and/or mineral oils, fatty esters such as mono-, di-, and triglycerides, silicone oils such as polydimethylsiloxanes (e.g. dimethicone) and mixtures thereof
fabric conditioning agents for example quaternary ammonium compounds having 1 to 3, preferably 2 optionally substituted (C8-C24) alk(en)yl chains attached to the nitrogen atom by one or more ester groups; hydrophobic monoparticles such as a sucrose polyester for example sucrose tetra-tallowate; silicones for example polydimethylsiloxane
thickening agents for example hydrophobically modified cellulose ethers such as modified hydroxyethylcelluloses
dyes for example dyes intended to change the colour of fabrics, fibres, skin or hair.
UV protecting agents such as sunscreens for example octyl methoxycinnamate (Parsol MCX), butyl methoxydibenzoylmethane (Parsol 1789) and benzophenone-3 (Uvinul M-40), ferulic acid.
bleach or bleach precursors for example 6-N-phthalimidoperoxyhexanoic acid (PAP) or photobleaching compounds. Dispersing the bleach from the porous bodies of the present invention results in the bleach being more finely dispersed and reduces the spot damage seen when larger particles of the bleach contact a fabric
antioxidants for example hydrophobic vitamins such as vitamin E, retinol, antioxiants based on hydroxytoluene such as Irganox or commercially available antioxidants such as the Trollox series.
insecticides, pesticides, herbicides that are stored as solid compositions before use but which are made up into liquid for spraying onto animals or crops
perfumes or flavourings or precursors thereto
pharmaceutically or veterinary active materials. There is a need for pharmaceutical compositions which can be taken by the consumer without the need to ingest the composition with a drink such as water. These compositions interact with the moisture in the oral cavity to release the active ingredient which is then ingested by the consumer. By incorporating the pharmaceutically or veterinary active molecule in the porous bodies of the present invention, pharmaceutical compositions which meet this need can be prepared.
In a similar way to that described above pharmaceutical and veterinary active ingredients may be formulated so that they release the active material into the nasal, occular, pulmonary or rectal cavities or on the skin where they may act topically or they may be absorbed transdermally to act systemically
By using the appropriate polymeric material in the lattice of the porous bodies of the present invention, porous bodies can be made that remain intact until the conditions (for example temperature or pH) change to those under which dispersion can occur. Thus dispersion can be delayed until a certain temperature has been reached or until the pH has changed to a suitable value such as would occur as the porous bodies pass down the GI tract. The acidity in the GI tract reduces down the GI tract and porous bodies which disperse hydrophobic actives only when the porous bodies are exposed to higher pH conditions enable pharmaceutically or veterinary active materials to be released only in the intestine having passed through the stomach intact.

Examples of situations where the porous bodies of the present invention are used to incorporate a hydrophobic material into a product during the manufacture of that product include:—
the introduction of hydrophobic materials such as fluorescers; enzymes; bleaches; hydrophobic polymers for example hydrophobically modified polyacrylates, silicones, hydrophobically modified polyvinylpyrrolidone, sulpha alkyl polysaccharides, Jaguar and JR polymers; fatty alcohols or acids; dyes for example shading dyes or black dyes for colour recovery into laundry products.
the use of porous bodies according to the present invention containing hydrophobic dyes in the manufacture of water soluble inkjet compositions.
the introduction of porous bodies containing different hydrophobic materials enables a manufacturer to produce a single base formulation into which the desired hydrophobic materials may be introduced by the use of the appropriate porous body of the present invention.
the use of porous bodies containing hydrophobic polymers which disperse into water as the lattice breaks down to form a latex. The use of such latexes containing appropriate hydrophobic polymers deposited onto fabric imparts crease resistance or easy-iron properties to the fabric.

The porous bodies of the present invention may include within the lattice, water soluble materials which will be dispersed when the polymeric bodies are dispersed in an aqueous medium. The water soluble materials may be incorporated into the lattice by dissolving them in the liquid medium from which they are made. Examples of suitable water soluble materials include:—Water soluble vitamins such as vitamin C; water soluble fluorescers such as 4,4′-bis(sulfostyryl)biphenyl disodium salt (sold under the trade name Tinopal CBS-X; activated aluminium chlorohydrate; transition metal complexes used as bleaching catalysts; water soluble polymers such as polyesters isophthalic acid), gerol, xanthan gum, or polyacrylates; diethylenetriaminepentaacetic acid (DTPA); primary and secondary alcohol sulphates containing greater than C8 chain length for example the materials known commercially as cocoPAS or mixtures thereof

The porous bodies of the present invention may include within the lattice, materials which will be dispersed as very small particles when the polymeric bodies are dispersed in an aqueous medium. These materials may be incorporated into the lattice by dissolving or dispersing them in the liquid medium from which the porous bodies are made. If the particles are less than 1 micron, preferably less than 0.5 micron and they are incorporated into skincare products then the particles will not be felt by the user as the dispersed porous bodies are applied to the skin.

The intrusion volume of the porous polymeric bodies as measured by mercury porosimetry (as hereinafter described) of each polymeric bodies is at least about 3 ml/g, more preferably at least about 4 ml/g, even more preferably at least about 5 ml/g, and most preferably at least about 6 ml/g. For example, the intrusion volume may be from about 3 ml/g to about 30 ml/g, preferably from about 4 ml/g to about 25 ml/g, more preferably from about 10 ml/g to about 20 ml/g. Intrusion volume provides a very good measure (in materials of this general type) of the total pore volume within the porous bodies of the present invention.—The polymeric porous bodies may be in the form of powders, beads (but not spherical beads having an average bead diameter of 0.2 to 5 mm) or moulded bodies. Powders may be prepared by the disintegration of polymeric porous bodies in the form of beads or moulded bodies either before or after freeze-drying.

In accordance with another aspect of the present invention, there is provided a method for water dispersible or water soluble porous bodies comprising a three dimensional open-cell lattice containing

10 (a) 10 to 95% by weight of a water soluble polymeric material and

(b) 5 to 90% by weight of a surfactant,

said porous bodies having an intrusion volume as measured by mercury porosimetry (as herein described) of at least about 3 ml/g

with the proviso that said porous body is not a spherical bead having an average bead diameter of 0.2 to 5 mm

comprising the steps of:

a) providing an intimate mixture of the polymeric material and the surfactant in a liquid medium b)

providing a fluid freezing medium at a temperature effective for rapidly freezing the liquid medium;

c) cooling the liquid medium with the fluid freezing medium at a temperature below the freezing point of the liquid medium for a period effective to rapidly freeze the liquid medium; and

(d) freeze-drying the frozen liquid medium to form the polymeric bodies by removal of the liquid medium by sublimation.

The intimate mixture of the polymeric material and the surfactant in the liquid medium may be an oil-in-water emulsion comprising a continuous aqueous phase containing the polymeric material, a discontinuous oil phase and the surfactant.

When the porous body is to be in the form of a powder the cooling of the liquid medium may be accomplished by spraying the liquid medium in atomised form into the fluid freezing medium. When the porous body is to be in the form of beads the cooling of the liquid medium may be accomplished by dropping drops of the liquid medium into the fluid freezing medium. Porous bodies in the form of moulded bodies may be made by pouring the liquid medium into a mould and cooling the liquid medium by the fluid freezing medium. In a preferred process of the invention to make moulded bodies, the liquid medium is poured into a pre-cooled mould surrounded by fluid freezing medium.

The frozen liquid medium may be freeze-dried by exposing the frozen liquid medium to high vacuum. The conditions to be used will be well known to those skilled in the art and the vacuum to be applied and the time taken should be such that all the frozen liquid medium present has been removed by sublimation. In the case of moulded porous polymeric bodies the freeze drying may take place with the frozen liquid medium still in the mould. Alternatively, the frozen liquid medium may be removed from the mould and freeze-dried in a commercial freeze-drier. The freeze-drying step may be performed for up to around 72 hours in order to obtain the porous bodies of the present invention.

The above process preferably uses an oil-in-water emulsion which comprises a continuous aqueous phase with the polymeric material dissolved therein, a discontinuous oil phase and the surfactant which is to be incorporated into the porous bodies of the present invention and which acts as an emulsifier for the emulsion. Preferably, the polymeric material is present in the continuous phase in a concentration of about 1% to 50% by weight. Even more preferably, the polymeric material is present in the continuous phase in a concentration of about 3% to 10% by weight.

Surfactants suitable for use as emulsifiers in oil-in-water emulsions preferably have an HLB value in the range 8 to 18. It is preferred that the surfactant is present in the liquid medium in a concentration of about 1% to about 60% by weight. More preferably, the surfactant is present in the liquid medium in a concentration of about 2% to about 40% by weight and a yet more preferred concentration is about 5% to about 25% by weight.

The discontinuous oil phase of the oil-in-water emulsion preferably comprises a material which is immiscible with the continuous phase, which freezes at a temperature above the temperature which is effective for rapidly freezing the liquid medium and which is removable by sublimation during the freeze drying stage. The discontinuous oil phase of the emulsion may be selected from one or more from the following group of organic solvents:—

alkanes such as heptane, n-hexane, isooctane, dodecane, decane; cyclic hydrocarbons such as toluene, xylene, cyclohexane; halogenated alkanes such as dichloromethane, dichoroethane, trichloromethane (chloroform), fluorotrichloromethane and tetrachloroethane;

esters such as ethyl acetate;

ketones such as 2-butanone;

ethers such as diethyl ether;

volatile cyclic silicones such as cyclomethicone;

and mixtures thereof

Preferably, the organic solvent comprises from about 10% to about 95% v/v of the emulsion, more preferably from about 20% to about 60% v/v. A preferred solvent is cyclohexane as the freezing point of cyclohexane is higher than that of water and the specific heat capacity for cyclohexane is much lower than that of water. This induces rapid freezing of the emulsion.

In the process of the invention the fluid freezing medium is preferably inert to the polymeric material. Preferably, the fluid medium is at a temperature below the freezing point of all of the components and is preferably at a much lower temperature to facilitate rapid freezing. The fluid freezing medium is preferably a liquified substance which is a gas or Vapour at standard temperature and pressure. The liquified fluid freezing medium may be at its boiling point during the freezing of the liquid medium or it may be cooled to below its boiling point by external cooling means. The fluid freezing medium may be selected from one or more of the following group; liquid air, liquid nitrogen (b.p. −196° C.), liquid ammonia (b.p. −33° C.), liquified noble gas such as argon, liquefied halogenated hydrocarbon such as trichloroethylene, chlorofluorocarbons such as Freon (RTM), hexane, dimethylbutene, isoheptane or cumene. Mixtures of organic liquids and solid carbon dioxide may also be used as the fluid freezing medium. Examples of suitable mixtures include chloroform or acetone and solid carbon dioxide (−77° C. and diethyl ether and solid carbon dioxide (−100° C.). The fluid medium is removed during freeze drying preferably under vacuum and may be captured for reuse. Due to the very low boiling temperature, inertness, ease of expulsion and economy, liquid nitrogen is the preferred fluid freezing medium.

The emulsions are typically prepared under conditions which are well known to those skilled in the art, for example, by using a magnetic stirring bar, a homogenizer, or a rotator mechanical stirrer.

The porous polymeric bodies produced usually comprise of two types of pores which are produced during the freeze drying step. One is from the sublimation of solid ice. This pore structure can be varied by varying the polymer, the polymer molecular weight, the polymer concentration, the nature of the discontinuous phase and/or the freezing temperature. The other kind of pore structure results from the sublimation of the oil phase material whereby the oil droplet structure found in the frozen porous bodies are replicated in the porous bodies.

The method for producing porous bodies according to the present invention, will now be more particularly described, byway of example only, with reference to the accompanying Examples.

In the Examples that follow the intrusion volume and bulk density are measured by mercury porosimetry as described below and the dissolution time is measured as described below.

Mercury Porosimetry

Pore intrusion volumes and bulk densities were recorded by mercury intrusion porosimetry using a Micromeritics Autopore IV 9500 porosimeter over a pressure range of 0.10 psia to 60000.00 psia. Intrusion volumes were calculated by subtracting the intrusion arising from mercury interpenetration between beads (pore size >150 μm) from the total intrusion.

Dissolution Time

A weighed sample of the polymeric bodies was stirred gently with water until the stirred mixture was clear to the eye. The time at which the mixture became clear to the eye was recorded as the dissolution time

### EXAMPLE 1

An experiment was conducted in order to produce a highly porous, rapidly dissolving water-soluble powder in which the polymeric material is polyvinyl alcohol. The powder contained 50% w/w polymer and 50% w/w surfactant. This powder was prepared by freezing an atomised oil-in-water emulsion in liquid nitrogen. The emulsion comprised an aqueous continuous phase containing polyvinyl alcohol and a discontinuous phase comprising cyclohexane. Sodium dodecyl sulphate (SDS) was used as the surfactant.

A 5% aqueous solution of polyvinyl alcohol was prepared by adding polyvinyl alcohol (PVA ex Aldrich, M_{w}=9000-10000, 80% hydrolysed) to deionised water. A sample of the solution (2 ml) was stirred with a type RW11 Basic IKA paddle stirrer, and SDS (0.1 g-98%, ex Aldrich) was added followed by cyclohexane (0.5 ml) to form an emulsion having 20% v/v of discontinuous phase. The emulsion was sprayed into liquid nitrogen from an airbrush. The frozen emulsion was placed in a freeze-drier overnight.

The intrusion volume and the bulk density were measured using mercury porosimetry as described above. The dissolution time for the powder (100 mg in 2 ml water at 20° C. stirred at 250 rpm) is given in Table 2.

TABLE 2

| % Discontinuous | Intrusion Volume | Bulk density | Dissolution time |
|---|---|---|---|
| phase | (ml/g) | (g/ml) | at 8° C. (minutes) |
| 20 | 15.21 | 0.0884 | 4.08 |

For comparison the polyvinyl alcohol as supplied from the manufacturer had a dissolution time of about 23 minutes and the solid obtained by freeze drying a 3% aqueous solution of the polyvinyl alcohol had a dissolution time of 12 minutes. The formation of the porous powders therefore enables the polyvinyl alcohol to be dissolved in an aqueous medium much more rapidly than is seen with the untreated polymer.

### EXAMPLE 2

An experiment was conducted in order to produce a highly porous, rapidly dissolving water-soluble powder in which the polymeric material is polyethyleneglycol (PEG). The powder contained 66.7% w/w polymer and 33.3% w/w surfactant. This powder was prepared by freezing an atomised oil-in-water emulsion in liquid nitrogen. The emulsion comprised an aqueous continuous phase containing PEG and a discontinuous phase comprising cyclohexane. Sodium dodecyl sulphate (SDS) was used as the surfactant.

A 10% aqueous solution of PEG was prepared by adding PEG (PEG ex Aldrich, M_{w}=10000) to deionised water. A sample of the solution (2 ml) was stirred with a type RW11 Basic IKA paddle stirrer, and SDS (01.g-98%, ex Aldrch) was added followed by cyclohexane (6 ml) to form an emulsion having 75% v/v of discontinuous phase. The emulsion was sprayed into liquid nitrogen using an air-brush. The frozen emulsion was placed in a freeze-dRer overnight.

The solid obtained by freeze drying a 10% aqueous solution of the PEG had a bulk density of 0.1034 g/ml whereas the polymeric body prepared in Example 2 had a bulk density of 0.0500 g/ml.

### EXAMPLE 3

An experiment was conducted in order to produce a highly porous, rapidly dissolving powder in which the polymeric material is sodium carboxymethylcellulose (SCMC). The bodies contain about 37.5% polymeric material and about 62.5% w/w of surfactant. This body was prepared by freezing an oil-in-water emulsion in liquid nitrogen. The emulsion comprised an aqueous continuous phase containing sodium carboxymethylcellulose and a discontinuous phase comprising cyclohexane. Sodium dodecyl sulphate (SDS) was used as the surfactant.

A 3% aqueous solution of SCMC was prepared by adding SCMC (SCMC ex Aldrich, M_{w}=90000) to deionised water. A sample of the solution (6 ml) was stirred with a type RW11 Basic IKA paddle stirrer, and SDS (0.3 g-98%, ex Aldrich) was added followed by sufficient cyclohexane to form an emulsion having 40% v/v of discontinuous phase. A sample with no cyclohexane (0% discontinuous phase) was also produced in a similar manner. The emulsion was sprayed into liquid nitrogen using an air-brush. The frozen emulsion was placed in a freeze-drier overnight.

The dissolution time for the bodies (100 mg in 2 ml water at 20° C. stirred at 250 rpm) are given in Table 3.

TABLE 3

| % Discontinuous | Intrusion Volume | Bulk density | Dissolution time |
|---|---|---|---|
| phase | (ml/g) | (g/ml) | at 20° C. (minutes) |
| 0 | 12.38 | 0.071 | 2.33 |
| 40 | 16.30 | 0.056 | 1.80 |

For comparison the SCMC as supplied by the manufacturer had a dissolution time of about 31 minutes at 20° C. and the SCMC obtained by freeze drying a 3% aqueous solution of the SCMC had a dissolution time of about 13 minutes at 20° C. The formation of the porous powders therefore enables the SCMC to be dissolved in an aqueous medium much more rapidly than is seen with the untreated polymer.

### EXAMPLE 4

An experiment was conducted in order to produce a highly porous, rapidly dissolving water-soluble powder containing a hydrophilic dye in which the polymeric material is polyvinyl alcohol. This powder was prepared by freezing an atomised oil-in-water emulsion in liquid nitrogen. The emulsion comprised an aqueous continuous phase containing polyvinyl alcohol and the dye and a discontinuous phase comprising cyclohexane. Sodium dodecyl sulphate (SDS) was used as the surfactant.

### EXAMPLE 4a

A 5% aqueous solution of polyvinyl alcohol was prepared by adding polyvinyl alcohol (PVA ex Aldrich, M_{w}=9000-10000, 80% hydrolysed) to deionised water. A sample of the solution (2 ml) was stirred with a type RW11 Basic IKA paddle stirrer, and Nile red dye (0.0004 g) and SDS (0.1 g-98%, ex Aldrich) were added followed by cyclohexane (2 ml) to form an emulsion having 50% v/v of discontinuous phase. The emulsion was sprayed into liquid nitrogen from an airbrush. The frozen emulsion was placed in a freeze-drier overnight. The powder contained around 49.9% w/w polymer, 49.9% w/w surfactant and around 0.2% w/w dye. The intrusion volume was determined as 14.18 ml/g.

When the powder was exposed to an aqueous medium the powder dispersed quickly and the dye was uniformly dispersed through the resulting solution.

### EXAMPLE 4b

A 5% aqueous solution of polyvinyl alcohol was prepared by adding polyvinyl alcohol (PVA ex Aldrich, M_{w}=9000-10000, 80% hydrolysed) to deionised water. A sample of the solution (2 ml) was stirred with a type RW11 Basic IKA paddle stirrer, and direct yellow 50 (0.01 g) and SDS (0.1 g-98%, ex Aldrich) were added followed by cyclohexane (6 ml) to form an emulsion having 75% v/v of discontinuous phase. The emulsion was sprayed into liquid nitrogen from a trigger spray. The frozen emulsion was placed in a freeze-drier overnight. The powder contained around 47.5% w/w polymer, around 47.5% waw surfactant and around 5% wAw of the dye.

The dissolution time for the resulting powder (100 mg in 2 ml water stirred at 250 rpm) was 45 seconds at 20° C. For comparison the polyvinyl alcohol as supplied from the manufacturer had a dissolution time of about 23 minutes and the solid obtained by freeze drying a 3% aqueous solution of the polyvinyl alcohol had a dissolution time of 12 minutes. The formation of the porous powders therefore enables the polyvinyl alcohol to be dissolved in an aqueous medium much more rapidly than is seen with the untreated polymer. The dye was uniformly dispersed through the resulting solution.

### EXAMPLE 5

An experiment was conducted in order to produce a highly porous, rapidly dissolving water-soluble powder containing a hydrophobic material in which the polymeric material is polyvinyl alcohol. This powder was prepared by freezing an atomised oil-in-water emulsion in liquid nitrogen. The emulsion comprised an aqueous continuous phase containing polyvinyl alcohol and a discontinuous phase comprising a solution of the hydrophobic material in cyclohexane which comprises the discontinuous phase of the emulsion. Sodium dodecyl sulphate (SDS) was used as the surfactant.

### EXAMPLE 5a

A 5% aqueous solution of polyvinyl alcohol was prepared by adding polyvinyl alcohol (PVA ex Aldrich, M_{w}=9000-10000, 80% hydrolysed) to deionised water. A sample of the solution (2 ml) was stirred with a type RW11 Basic IKA paddle stirrer and SDS (0.1 g-98%, ex Aldrich) were added followed by a solution of oil red dye (0.0004 g) in cyclohexane (2 ml) to form an emulsion having 50% v/v of discontinuous phase. The emulsion was sprayed into liquid nitrogen from an airbrush. The frozen emulsion was placed in a freeze-drier overnight. The powder contained around 49.9% w/w polymer, 49.9% w/w surfactant and around 0.2% w/w dye.

The dissolution time for the resulting powder (100 mg in 2 ml water stirred at 250 rpm) was 16 seconds at 20° C. For comparison the polyvinyl alcohol as supplied from the manufacturer had a dissolution time of about 23 minutes and the solid obtained by freeze drying a 3% aqueous solution of the polyvinyl alcohol had a dissolution time of 12 minutes. The formation of the porous powders therefore enables the polyvinyl alcohol to be dissolved in an aqueous medium much more rapidly than is seen with the untreated polymer and for the hydrophobic dye to be dispersed in the aqueous medium. The dye was uniformly dispersed through the resulting solution. The dye is not soluble in water it cannot be dissolved or dispersed in aqueous medium if it has not been incorporated into the powder of the present invention without using specific processing conditions known to those skilled in the art such as high shear mixing and ultrasonic treatment.

### EXAMPLE 5b

A 2.5% aqueous solution of polyvinyl alcohol was prepared by adding polyvinyl alcohol (PVA ex Aldrich, M_{w}=9000-10000, 80% hydrolysed) to deionised water. A sample of the solution (2 ml) was stirred with a type RW11 Basic IKA paddle stirrer and SDS (0.12 g-98%, ex Aldrich) were added followed by a 1% solution of triclosan (TCN) in cyclohexane (2 ml) to form an emulsion having 50% v/v of discontinuous phase. The emulsion was sprayed into liquid nitrogen from a trigger spray. The frozen emulsion was placed in a freeze-drier overnight. The powder contained about 26% w/w of polymer, about 63% w/w of surfactant and about 11% w/w of triclosan.

The dissolution time for the resulting powder (100 mg in 2 ml water stirred at 250 rpm) was 25 seconds at 20° C. For comparison the polyvinyl alcohol as supplied from the manufacturer had a dissolution time of about 23 minutes and the solid obtained by freeze drying a 3% aqueous solution of the polyvinyl alcohol had a dissolution time of 12 minutes. The formation of the porous powders therefore enables the polyvinyl alcohol to be dissolved in an aqueous medium much more rapidly than is seen with the untreated polymer.

### EXAMPLE 5c

A 2.5% aqueous solution of polyvinyl alcohol was prepared by adding polyvinyl alcohol (PVA ex Aldrich, M_{w}=9000-10000, 80% hydrolysed) to deionised water. A sample of the solution (2 ml) was stirred with a type RW11 Basic IKA paddle stirrer and SDS (0.12 g-98%, ex Aldrich) were added followed by a 1% solution of the fluorescer 2,5-bis(2-benzoxazolyl)thiophene (sold under the trade name Tinopal SOP) in dichloromethane (2 ml) to form an emulsion having 50% v/v of discontinuous phase. The emulsion was sprayed into liquid nitrogen from a trigger spray. The frozen emulsion was placed in a freeze-drier overnight.

The dissolution time for the resulting powder. The powder contained about 26% w/w of polymer, about 63% w/w of surfactant and about 11% w/w of the fluorescer. The dissolution time for the resulting powder (100 mg in 2 ml water stirred at 250 rpm) was 25 seconds at 20° C. For comparison the polyvinyl alcohol as supplied from the manufacturer had a dissolution time of about 23 minutes and the solid obtained by freeze drying a 3% aqueous solution of the polyvinyl alcohol had a dissolution time of 12 minutes. The formation of the porous powders therefore enables the polyvinyl alcohol to be dissolved in an aqueous medium much more rapidly than is seen with the untreated polymer. No particles of the fluorescer could be observed in the solution showing that it had been uniformly dispersed.

### EXAMPLE 6

An experiment was conducted in order to produce a highly porous, rapidly dissolving water-soluble moulded body in which the polymeric material is polyvinyl alcohol. The body contains about 44% w/w of polymeric material and about 56% w/w of surfactant. This body was prepared by freezing an oil-in-water emulsion in liquid nitrogen. The emulsion comprised an aqueous continuous phase containing polyvinyl alcohol and a discontinuous phase comprising cyclohexane. Sodium dodecyl sulphate (SDS) was used as the surfactant.

A 10% aqueous solution of polyvinyl alcohol was prepared by adding polyvinyl alcohol (PVA ex Aldrich, M_{w}=9000-10000, 80% hydrolysed) to deionised water. A sample of the solution (6 ml) was stirred with a type RW11 Basic IKA paddle stirrer, and SDS (0.75 g-98%, ex Aldrich) was added followed by cyclohexane (18 ml) to form an emulsion having 75% v/v of discontinuous phase. The emulsion was placed in a beaker which was placed in a thermostatic vessel containing liquid nitrogen. The frozen beaker was placed in a freeze-drier overnight.

In a similar manner to that described above porous bodies were prepared from emulsions having 10%, 20%, 40% and 60% v/v of discontinuous phase. The emulsions from which these bodies were prepared using PVA (5 wt % solution) and SDS (0.05 g/ml PVA solution) and the appropriate volume of cyclohexane. The intrusion volume and the bulk density were measured using mercury porosimetry as described above. The dissolution time for the bodies (100 mg in 2 ml water stirred at 250 rpm) are given in Table 4.

TABLE 4

| % Discontinuous | Intrusion Volume | Bulk density | Dissolution time |
|---|---|---|---|
| phase | (ml/g) | (g/ml) | at 20° C. (minutes) |
| 0 | 6.38 | 0.13 | 1.0 |
| 10 | 6.10 | 0.13 | 1.1 |
| 20 | 7.13 | 0.089 | 0.68 |
| 40 | 9.26 | 0.092 | 0.58 |
| 60 | 10.69 | 0.084 | 0.63 |
| 75 | 21.86 | 0.032 | 0.33 |

For comparison the polyvinyl alcohol as supplied by the manufacturer had a dissolution time of about 23 minutes and the solid obtained by freeze drying a 3% aqueous solution of the polyvinyl alcohol had a dissolution time of about 12 minutes. The formation of the porous bodies therefore enables the polyvinyl alcohol to be dissolved in an aqueous medium much more rapidly than is seen with the untreated polymer.

### EXAMPLE 7

In a similar manner to that described in example 6, porous bodies were prepared from emulsions having 75% discontinuous phase but using nonoxynol 40 (sold under the trade name Igepal CO-890) as the surfactant. The amounts of nonoxynol 40 used are given below in Table 5. The dissolution time for the bodies (100 mg in 2 ml water stirred at 250 rpm) are given in Table 5

TABLE 5

| Amount of nonoxynol 40 (g/ml | Dissolution time at |
|---|---|
| of PVA solution | 20° C. (minutes) |
| 0.0043 | 12.6 |
| 0.016 | 7.68 |
| 0.043 | 5.13 |
| 0.107 | 3.4 |

For comparison the polyvinyl alcohol as supplied by the manufacturer had a dissolution time of about 23 minutes and the solid obtained by freeze drying a 3% aqueous solution of the polyvinyl alcohol had a dissolution time of about 12 minutes. The formation of the porous bodies therefore enables the polyvinyl alcohol to be dissolved in an aqueous medium much more rapidly than is seen with the untreated polymer.

### EXAMPLE 8

An experiment was conducted in order to produce a highly porous, rapidly dissolving water-soluble moulded body in which the polymeric material is sodium carboxymethylcellulose (SCMC). The bodies contain about 37.5% polymeric material and about 62.5% w/w of surfactant. This body was prepared by freezing an oil-in-water emulsion in liquid nitrogen. The emulsion comprised an aqueous continuous phase containing sodium carboxymethylcellulose and a discontinuous phase comprising cyclohexane. Sodium dodecyl sulphate (SDS) was used as the surfactant.

A 3% aqueous solution of SCMC was prepared by adding SCMC (SCMC ex Aldrich, M_{w}=90000) to deionised water. A sample of the solution (6 ml) was stirred with a type RW11 Basic IKA paddle stirrer, and SDS (0.3 g-98%, ex Aldrich) was added followed by cyclohexane (18 ml) to form an emulsion having 75% v/v of discontinuous phase. The emulsion was placed in a beaker which was placed in a thermostatic vessel containing liquid nitrogen. The frozen beaker was placed in a freeze-drier overnight.

In a similar manner to that described above porous bodies were prepared from emulsions having 20%, 40% and 60% v/v of discontinuous phase. The emulsions were prepared using SCMC (3 wt % solution of SCMC of MW 90000) and SDS (0.05 g/ml SCMC solution) and the appropriate volume of cyclohexane.

The intrusion volume and the bulk density were measured using mercury porosimetry as described above. The dissolution time for the bodies (100 mg in 2.5 ml water at 8° C. or 100 mg in 2 ml water at 20° C. stirred at 250 rpm) are given in Table 6.

TABLE 6

| | | | Dissolution | Dissolution |
|---|---|---|---|---|
| | Intrusion | Bulk | time at | time at |
| % Discontinuous | Volume | density | 8° C. | 20° C. |
| phase | (ml/g) | (g/ml) | (minutes) | (minutes) |
| 0 | 7.76 | 0.106 | 10.13 | 2.47 |
| 20 | 10.54 | 0.0845 | 4.65 | 1.58 |
| 40 | 13.35 | 0.0665 | 3.38 | 0.8 |
| 60 | 18.63 | 0.0389 | 2.82 | 0.42 |
| 75 | 29.67 | 0.0308 | 2.42 | 0.32 |

For comparison the SCMC as supplied by the manufacturer had a dissolution time of about 31 minutes at 20° C. and the SCMC obtained by freeze drying a 3% aqueous solution of the SCMC had a dissolution time of about 12 minutes at 8° C. and about 13 minutes at 20° C. The formation of the moulded bodies therefore enables the SCMC to be dissolved in an aqueous medium much more rapidly than is seen with the untreated polymer.

### EXAMPLE 9

In a similar manner to that described in Example 8, porous bodies in which the polymeric material is SCMC were prepared from emulsions having 75% discontinuous phase but using different amounts of SDS as the surfactant. The amounts of SDS used are given below in Table 7. The dissolution time for the bodies (100 mg in 2 ml water stirred at 250 rpm) are given in Table 7.

TABLE 7

| Amount of SDS (g/ml | Dissolution time at |
|---|---|
| of SCMC solution | 20° C. (minutes) |
| 0.0079 | 7.12 |
| 0.0182 | 5.12 |
| 0.039 | 5.13 |
| 0.10 | 1.8 |

### EXAMPLE 10

In a similar manner to that described in example 8, porous bodies in which the polymeric material is SCMC were prepared from emulsions having 75% discontinuous phase but using nonoxynol 40 (sold under the trade name Igepal CO-890) as the surfactant. The amounts of nonoxynol 40 used are given below in Table 3C. The dissolution time for the bodies (100 mg in 2 ml water stirred at 250 rpm) are given in Table 8.

TABLE 8

| Amount of nonoxynol | Dissolution time at |
|---|---|
| 40 (g/ml of PVA solution | 20° C. (minutes) |
| 0.0029 | 20.1 |
| 0.009 | 13.8 |
| 0.0356 | 11.42 |
| 0.0444 | 14.48 |

### EXAMPLE 11

An experiment was conducted in order to produce a highly porous, rapidly dissolving water-soluble moulded body in which the polymeric material is polyethyleneglycol (PEG). The body contains about 66.7% w/w of polymeric material and about 33.3% of surfactant. This body was prepared by freezing an oil-in-water emulsion in liquid nitrogen. The emulsion comprised an aqueous continuous phase containing PEG and a discontinuous phase comprising cyclohexane. Sodium dodecyl sulphate (SDS) was used as the surfactant.

A 10% aqueous solution of PEG was prepared by adding PEG (PEG ex Aldrich, M_{w}=10000) to deionised water. A sample of the solution (2 ml) was stirred with a type RW11 Basic IKA paddle stirrer, and SDS (0.1 g-98%, ex Aldrich) was added followed by cyclohexane (6 ml) to form an emulsion having 75% v/v of discontinuous phase. The emulsion was placed in a beaker which was placed in a thermostatic vessel containing liquid nitrogen. The frozen beaker was placed in a freeze-drier overnight.

In a similar manner to that described above porous bodies were prepared from emulsions having 10% and 20% v/v of discontinuous phase. The emulsions were prepared using PEG (10 wt % solution of PEG of MW 10000) and SDS (0.05 g/ml PEG solution) and the appropriate volume of cyclohexane.

The intrusion volume and the bulk density were measured using mercury porosimetry as described above. The dissolution time for the bodies (100 mg in 2 ml water stirred at 250 rpm) are given in Table 9.

TABLE 9

| % Discontinuous | Intrusion Volume | Bulk density | Dissolution time |
|---|---|---|---|
| phase | (ml/g) | (g/ml) | at 20° C. (minutes) |
| 0 | 5.26 | 0.12 | 0.33 |
| 10 | 5.67 | 0.14 | 0.40 |
| 20 | 6.51 | 0.13 | 0.42 |
| 75 | 17.31 | 0.04 | 0.35 |

### EXAMPLE 12

An experiment was conducted in order to produce a highly porous, rapidly dissolving water-soluble moulded polymeric in which the polymeric material is dextran. The body contains about 50% polymeric material and about 50% of surfactant. This body was prepared by freezing an oil-in-water emulsion in liquid nitrogen. The emulsion comprised an aqueous continuous phase containing dextran and a discontinuous phase comprising cyclohexane. Sodium dodecyl sulphate (SDS) was used as the surfactant.

A 5% aqueous solution of dextran was prepared by adding dextran (ex Fluka MW=11000) to deionised water. A sample of the solution (2 ml) was stirred with a type RW11 Basic IKA paddle stirrer, and SDS (0.1 g-98%, ex Aldrich) was added followed by cyclohexane (6 ml) to form an emulsion having 75% v/v of discontinuous phase. The emulsion was placed in a beaker which was placed in a thermostatic vessel containing liquid nitrogen. Once frozen, the beaker was placed in a freeze-drier overnight.

In a similar manner to that described above porous bodies were prepared from emulsions having 10% and 20% v/v of discontinuous phase. The emulsions were prepared using dextran (5 wt % solution of dextran of MW 11000) and SDS (0.05 g/ml SCMC solution) and the appropriate volume of cyclohexane.

The intrusion volume and the bulk density were measured using mercury porosimetry as described above. The dissolution time for the bodies (100 mg in 2 ml water stirred at 250 rpm) are given in Table 10.

TABLE 10

| % Discontinuous | Intrusion Volume | Bulk density | Dissolution time |
|---|---|---|---|
| phase | (ml/g) | (g/ml) | at 20° C. (minutes) |
| 0 | 7.06 | 0.093 | 1.15 |
| 10 | 7.67 | 0.088 | 0.75 |
| 20 | 7.70 | 0.11 | 0.65 |
| 75 | 24.38 | 0.03 | 0.25 |

For comparison dextran obtained by freeze drying a 5% aqueous solution of the dextran had a dissolution time of about 1.43 minutes

### EXAMPLE 13

An experiment was conducted in order to produce a highly porous, rapidly dissolving water-soluble moulded body in which the polymeric material is polyvinyl alcohol which can be used to disperse a hydrophilic dye into water. The body contains about 28% w/w polymeric material, about 69% w/w surfactant and about 3% w/w dye. This body was prepared by freezing an oil-in-water emulsion in liquid nitrogen. The emulsion comprised an aqueous continuous phase containing polyvinyl alcohol and the dye and a discontinuous phase comprising cyclohexane. Sodium dodecyl sulphate (SDS) was used as the surfactant.

A 5% aqueous solution of polyvinyl alcohol was prepared by adding polyvinyl alcohol (PVA ex Aldrich, M_{w}=9000-10000, 80% hydrolysed) to deionised water. A sample of the solution (2 ml) was stirred with a type RW11 Basic IKA paddle stirrer, Direct Yellow 50 dye (0.01 g and SDS (0.25 g-98%, ex Aldrich) was added followed by cyclohexane (6 ml) to form an emulsion having 75% v/v of discontinuous phase. The emulsion was placed in a beaker which was placed in a thermostatic vessel containing liquid nitrogen. The frozen beaker was placed in a freeze-drier overnight.

The dissolution time for the resulting moulded body (100 mg in 2 ml water) was 70 seconds at 20° C. The dye was uniformly dispersed through the resulting solution.

### EXAMPLE 14

An experiment was conducted in order to produce a highly porous, rapidly dissolving water-soluble moulded porous body in which the polymeric material is polyvinyl alcohol which can be used to disperse a hydrophobic material into water. This body was prepared by freezing an oil-in-water emulsion in liquid nitrogen. The emulsion comprised an aqueous continuous phase containing polyvinyl alcohol and a discontinuous phase comprising a solution of the hydrophobic material in cyclohexane. Sodium dodecyl sulphate (SDS) was used as the surfactant.

### EXAMPLE 14a

A 5% aqueous solution of polyvinyl alcohol was prepared by adding polyvinyl alcohol (PVA ex Aldrich, M_{w}=9000-10000, 80% hydrolysed) to deionised water. A sample of the solution (4 ml) was stirred with a type RW11 Basic IKA paddle stirrer, and SDS (0.5 g-98%, ex Aldrich) was added followed by a solution of Fat red 7B dye (0.01 g) in cyclohexane (12 ml) to form an emulsion having 75% v/v of discontinuous phase. The emulsion was placed in a beaker which was placed in a thermostatic vessel containing liquid nitrogen. The frozen beaker was placed in a freeze-drier overnight. The resulting moulded body contains about 28% w/w polymeric material, about 70% w/w surfactant and about 2% w/w dye.

The dissolution time for the resulting moulded body (100 mg in 2 ml water) was 10 seconds at 20° C. The dye was uniformly dispersed through the resulting solution imparting a red coloration to the solution. When attempts were made to disperse the dye in water, particles of dye remained at the bottom of the vessel and the water did not attain any red coloration.

For comparison the polyvinyl alcohol as supplied by the manufacturer had a dissolution time of about 23 minutes and the solid obtained by freeze drying a 3% aqueous solution of the polyvinyl alcohol had a dissolution time of about 12 minutes. The formation of the porous bodies therefore enables the polyvinyl alcohol to be dissolved in an aqueous medium much more rapidly than is seen with the untreated polymer and facilitates the dispersion of the dye.

### EXAMPLE 14b

A 5% aqueous solution of polyvinyl alcohol was prepared by adding polyvinyl alcohol (PVA ex Aldrich, M_{w}=9000-10000, 80% hydrolysed) to deionised water. A sample of the solution (4 ml) was stirred with a type RW11 Basic IKA paddle stirrer, and SDS (0.4 g-98%, ex Aldrich) was added followed by a solution of oil blue dye (0.0014 g) in cyclohexane (12 ml) to form an emulsion having 75% v/v of discontinuous phase. The emulsion was placed in a beaker which was placed in a thermostatic vessel containing liquid nitrogen. Once frozen, the beaker was placed in a freeze-drier overnight. The resulting moulded body contained about 33.3% w/w polymeric material, about 66.5% w/w surfactant and about 0.2% w/w dye.

When the body was exposed to an aqueous medium, the dye was uniformly dispersed through the resulting solution imparting a blue coloration to the solution. When attempts were made to disperse the dye in water, particles of dye remained at the bottom of the vessel and the water did not attain any blue coloration.

### EXAMPLE 14c

A 5% aqueous solution of polyvinyl alcohol was prepared by adding polyvinyl alcohol (PVA ex Aldrich, M_{w}=9000-10000, 80% hydrolysed) to deionised water. A sample of the solution (6 ml) was stirred with a type RW11 Basic IKA paddle stirrer, and SDS (0.75 g-98%, ex Aldrich) was added followed by a solution of 6-N-phthalimidoperoxyhexanoic acid (PAP 0.1 g) in cyclohexane (18 ml) to form an emulsion having 75% v/v of discontinuous phase. The emulsion was placed in a beaker which was placed in a thermostatic vessel containing liquid nitrogen. The frozen beaker was placed in a freeze-drier overnight. The resulting moulded body contains about 26% w/w polymeric material, about 65% w/w surfactant and about 9% PAP.

It has been found that when the body prepared as above is dissolved in water and the solution is applied to fabric dyed with a dye, for example imidial green, the bleaching effect is still seen but the local spot damage that is caused by the presence of larger particles of the bleach is not observed.

### EXAMPLE 14d

A 2.5% aqueous solution of polyvinylalcohol was prepared by adding polyvinylalcohol (PVA ex Aldrich, Mw=9000-10000, 80% hydrolysed) to deionised water. A sample of the solution (12 ml) was stirred with a type RW11 Basic IKA paddle stirrer, and SDS (0.75 g-98%, ex Aldrich) was added followed by a solution of triclosan (0.12 g) in cyclohexane (12 ml) to form an emulsion having 50% v/v of discontinuous phase. The emulsion was placed in a beaker which was placed in a thermostatic vessel containing liquid nitrogen. The frozen beaker was placed in a freeze-drier overnight. The resulting moulded body contains about 26% w/w polymeric material, about 65% w/w surfactant and about 9% triclosan.

The dissolution time for the resulting moulded body (100 mg in 2 ml water) was 30 seconds at 20° C. For comparison the polyvinyl alcohol as supplied by the manufacturer had a dissolution time of about 23 minutes and the solid obtained by freeze drying a 3% aqueous solution of the polyvinyl alcohol had a dissolution time of about 12 minutes. The formation of the porous bodies therefore enables the polyvinyl alcohol to be dissolved in an aqueous medium much more rapidly than is seen with the untreated polymer and facilitates the dispersion of the hydrophobic material.

### EXAMPLE 14e

A 2.5% aqueous solution of polyvinylalcohol was prepared by adding polyvinylalcohol (PVA ex Aldrich, Mw=9000-10000, 80% hydrolysed) to deionised water. A sample of the solution (12 ml) was stirred with a type RW11 Basic IKA paddle stirrer, and SDS (0.75 g-98%, ex Aldrich) was added followed by a solution of 2,5-bis(2-benzoxazolyl)thiophene (0.12 g—a fluorescer sold under the trade name Tinopal SOP) in dichloromethane (12 ml) to form an emulsion having 50% v/v of discontinuous phase. The emulsion was placed in a beaker which was placed in a thermostatic vessel containing liquid nitrogen. The frozen beaker was placed in a freeze-drier overnight. The resulting moulded body contains about 26% w/w polymeric material, about 65% w/w surfactant and about 9% of the fluorescer The dissolution time for the resulting moulded body (100 mg in 2 ml water) was 30 seconds at 20° C. For comparison the polyvinyl alcohol as supplied by the manufacturer had a dissolution time of about 23 minutes and the solid obtained by freeze drying a 3% aqueous solution of the polyvinyl alcohol had a dissolution time of about 12 minutes. The formation of the porous bodies therefore enables the polyvinyl alcohol to be dissolved in an aqueous medium much more rapidly than is seen with the untreated polymer and facilitates the dispersion of the hydrophobic material.

### EXAMPLE 14f

A 5% aqueous solution of polyvinyl alcohol was prepared by adding polyvinyl alcohol (PVA ex Aldrich, M_{w}=9000-10000, 80% hydrolysed) to deionised water. A sample of the solution (4 ml) was stirred with a type RW11 Basic IKA paddle stirrer, and SDS (0.3 g-98%, ex Aldrich) was added followed by a 10% solution of polystyrene (a hydrophobic polymer) in cyclohexane (6 ml) to form an emulsion having 60% v/v of discontinuous phase. The emulsion was placed in a beakerwhich was placed in a thermostatic vessel containing liquid nitrogen. The frozen beaker was placed in a freeze-drier overnight. The resulting moulded body contains about 18% w/w polymeric material, about 27% w/w surfactant and about 55% w/w polystyrene. The dissolution time for the resulting moulded body (100 mg in 2 ml water) was 15 seconds at 20° C. The PS was uniformly dispersed as a latex in the dispersion of the PVA.

### EXAMPLE 14g

A 5% aqueous solution of polyvinyl alcohol was prepared by adding polyvinyl alcohol (PVA ex Aldrich, M_{w}=9000-10000, 80% hydrolysed) to deionised water. A sample of the solution (5 ml) was stirred with a type RW11 Basic IKA paddle stirrer, and SDS (0.3 g-98%, ex Aldrich) was added followed by a 9.45% solution of poly(DL-lactide-co-glycolide) 50% copolymer (PLG—a hydrophobic polymer) in cyclohexane (5 ml) to form an emulsion having 50% v/v of discontinuous phase. The emulsion was placed in a beaker which was placed in a thermostatic vessel containing liquid nitrogen. The frozen beaker was placed in a freeze-drier overnight. The resulting moulded body contains about 25% wlw polymeric material, about 29% w/w surfactant and about 46% w/w hydrophobic polymer. The dissolution time for the resulting moulded body (100 mg in 2 ml water) was 2 minutes at 20° C. The PLG was uniformly dispersed as a latex in the dispersion of the PVA

### EXAMPLE 14h

A 1.67% aqueous solution of polyvinyl alcohol was prepared by adding polyvinyl alcohol (PVA ex Aldrich, M_{w}=9000-10000, 80% hydrolysed) to deionised water. A sample of the solution (6 ml) was stirred with a type RW11 Basic IKA paddle stirrer, and SDS (0.25 g-98%, ex Aldrich) was added followed by a solution of polystyrene-block-polybutadiene-block-polystyrene copolymer (0.001 g MW 140000 ex Aldrich) in toluene (6 ml) to form an emulsion having 50% v/v of discontinuous phase. The emulsion was placed in a beaker which was placed in a thermostatic vessel containing liquid nitrogen. The frozen beaker was placed in a freeze-drier overnight. The resulting moulded body contains about 39% w/w polymeric material, about 49% w/w surfactant and about 12% w/w hydrophobic polymer. The dissolution time for the resulting moulded body (100 mg in 2 ml water) was 3 minutes at 20° C. The hydrophobic copolymer was uniformly dispersed as a latex in the dispersion of the PVA

### EXAMPLE 15

An experiment was conducted in order to produce highly porous, rapidly dissolving water-soluble porous bodies in which the polymeric material is SCMC which can be used to disperse a hydrophobic polymeric material into water. These bodies were prepared by freezing oil-in-water emulsion in liquid nitrogen. The emulsion comprised an aqueous continuous phase containing SCMC and a discontinuous phase comprising a solution of the hydrophobic material in toluene. Sodium dodecyl sulphate (SDS) was used as the surfactant.

A 3.3% aqueous solution of SCMC was prepared by adding SCMC to deionised water. A sample of the solution (6 ml) was stirred with a type RW11 Basic IKA paddle stirrer, and SDS (0.25 g-98%, ex Aldrich) was added followed by a solution of poly(methylmethacrylate) (0.06 g MW 350000 ex Aldrich) in toluene (6 ml) to form an emulsion having 50% v/v of discontinuous phase

### EXAMPLE 15a

The above emulsion was sprayed into liquid nitrogen from an airbrush. The frozen emulsion was placed in a freeze-drier overnight to give porous bodies in the form of a powder. The dissolution time for the resulting powder (100 mg in 2 ml water) was 1 minute at 20° C.

### EXAMPLE 15b

The above emulsion was placed in a beaker which was placed in liquid nitrogen to freeze the emulsion. The frozen emulsion in the beaker was placed in a freeze drier overnight to give a porous moulded body shaped as the inside of the beaker. The dissolution time for the resulting moulded body (100 mg in 2 ml water) was 40 seconds at 20° C.

### EXAMPLE 15c

A beaker was placed in a thermostatic vessel and liquid nitrogen was placed in both the beaker and the vessel. The emulsion prepared above was added dropwise from a needle to the liquid nitrogen in the beaker using a A-99 FZ Razel syringe pump. The beaker was placed in a freeze drier overnight to give spherical beads. The dissolution time for the resulting beads (100 mg in 2 ml water) was 1.2 minutes at 20° C.

### EXAMPLE 16

An experiment was conducted in order to produce highly porous, rapidly dissolving water-soluble porous bodies in which the polymeric material is SCMC which can be used to disperse a hydrophobic polymeric material and a hydrophobic active material into water. These bodies were prepared by freezing oil-in-water emulsion in liquid nitrogen. The emulsion comprised an aqueous continuous phase containing SCMC and a discontinuous phase comprising a solution of the hydrophobic polymer and the hydrophobic material in toluene. Sodium dodecyl sulphate (SDS) was used as the surfactant.

A 3.3% aqueous solution of SCMC was prepared by adding SCMC to deionised water. A sample of the solution (6 ml) was stirred with a type RW11 Basic IKA paddle stirrer, and SDS (0.25 g-98%, ex Aldrich) was added followed by a solution of poly(methylmethacrylate) (PMMA 0.06 g MW 350000 ex Aldrich) and 2,5-bis(2-benzoxazolyl)thiophene (0.12 g—a fluorescer sold under the trade name Tinopal SOP) in toluene (6 ml) to form an emulsion having 50% v/v of discontinuous phase

### EXAMPLE 16a

The above emulsion was sprayed into liquid nitrogen from an airbrush. The frozen emulsion was placed in a freeze-drier overnight to give porous bodies in the form of a powder. The dissolution time for the resulting powder (100 mg in 2 ml water) was 30 seconds at 20° C.

### EXAMPLE 16b

The above emulsion was placed in a beaker which was placed in liquid nitrogen to freeze the emulsion. The frozen emulsion in the beaker was placed in a freeze drier overnight to give a porous moulded body shaped as the inside of the beaker. The dissolution time for the resulting moulded body (100 mg in 2 ml water) was 30 seconds at 20° C.

### EXAMPLE 16c

A beaker was placed in a thermostatic vessel and liquid nitrogen was placed in both the beaker and the vessel. The emulsion prepared above was added dropwise from a needle to the liquid nitrogen in the beaker using a A-99 FZ Razel syringe pump. The beaker was placed in a freeze drier overnight to give spherical beads. The dissolution time for the resulting beads (100 mg in 2 ml water) was 1 minute at 20° C.

### EXAMPLE 17

An experiment was conducted in order to produce highly porous, rapidly dissolving water-soluble porous bodies in which the polymeric material is poly(2-N,N-dimethylaminoethylmethacrylate) [PDMAEMA]. These bodies were prepared by freezing an oil-in-water emulsion in liquid nitrogen. The emulsion comprised an aqueous continuous phase containing PDMAEMA and a discontinuous phase comprising cyclohexane. Sodium dodecyl sulphate (SDS) was used as the surfactant.

2-(Dimethylamino)ethyl methacrylate (10 g, 0.064 mol) and 2,2′-azobisisobutyronitrile (0.1 g, 0.61 mmol) were dissolved in dry tetrahydrofuran (100 ml). Dissolved oxygen in the solution was removed by bubbling nitrogen through the solution for 30 minutes. The reaction mixture was heated to 60° C. under a nitrogen atmosphere for 24 hours and then cooled to room temperature, concentrated in vacuo and the residue was dripped into cold petroleum ether (40-60° C. fraction) in order to precipitate the polymer. The polymer was filtered off and dried overnight under vacuum to give poly(2-N,N-dimethylaminoethylmethacrylate) as a white crystalline powder

A 5% aqueous solution of PDMAEMA was prepared by dissolving the PDMAEMA prepared above in deionised water. A sample of the solution (8 ml) was stirred with a type RW11 Basic IKA paddle stirrer, and SDS (1 g-98%, exAldrich) was added followed by cyclohexane (24 ml) to form an emulsion having 75% v/v of discontinuous phase

### EXAMPLE 17a

The above emulsion was sprayed into liquid nitrogen from an airbrush. The frozen emulsion was placed in a freeze-drier overnight to give porous bodies in the form of a powder.

### EXAMPLE 17b

The above emulsion was placed in a beaker which was placed in liquid nitrogen to freeze the emulsion. The frozen emulsion in the beaker was placed in a freeze drier overnight to give a porous moulded body shaped as the inside of the beaker.

### EXAMPLE 17c

A beaker was placed in a thermostatic vessel and liquid nitrogen was placed in both the beaker and the vessel. The emulsion prepared above was added dropwise from a needle to the liquid nitrogen in the beaker using a A-99 FZ Razel syringe pump. The beaker was placed in a freeze drier overnight to give spherical beads

PDMAEMA is insoluble in water at high temperatures but becomes soluble as the temperature drops. The porous bodies prepared above are therefore able to remain intact at higher temperatures but will dissolve or disperse at lower temperatures. Samples (100 mg) of the products of examples 17a, 17b and 17c were stirred with water at 65° C. and the solution allowed to cool. The temperature at which the bodies dissolved:—Example 17a 57° C., Example 17b 57 and Example 17c 55° C.

### EXAMPLE 18

An experiment was conducted in order to produce highly porous, rapidly dissolving water-soluble porous bodies in which the polymeric material is poly(2-N,N-dimethylaminoethylmethacrylate) [PDMAEMA] which can be used to disperse a hydrophobic material into water. These bodies were prepared by freezing an oil-in-water emulsion in liquid nitrogen. The emulsion comprised an aqueous continuous phase containing PDMAEMA and a discontinuous phase comprising a solution of the hydrophobic material in cyclohexane. Sodium dodecyl sulphate (SDS) was used as the surfactant.

A 5% aqueous solution of PDMAEMA was prepared by dissolving the PDMAEMA prepared in Example 17 above in deionised water. A sample of the solution (8 ml) was stirred with a type RW11 Basic IKA paddle stirrer, and SDS (1 g-98%, ex Aldrich) was added followed by a solution of solvent green 3 dye (0.02 g) in cyclohexane (24 ml) to form an emulsion having 75% v/v of discontinuous phase

### EXAMPLE 18a

The above emulsion was sprayed into liquid nitrogen from an airbrush. The frozen emulsion was placed in a freeze-drier overnight to give porous bodies in the form of a powder.

### EXAMPLE 18b

The above emulsion was placed in a beaker which was placed in liquid nitrogen to freeze the emulsion. The frozen emulsion in the beaker was placed in a freeze drier overnight to give a porous moulded body shaped as the inside of the beaker.

### EXAMPLE 18c

A beaker was placed in a thermostatic vessel and liquid nitrogen was placed in both the beaker and the vessel. The emulsion prepared above was added dropwise from a needle to the liquid nitrogen in the beaker using a A-99 FZ Razel syringe pump. The beaker was placed in a freeze drier overnight to give spherical beads.

PDMAEMA is insoluble in water at high temperatures but becomes soluble as the temperature drops. The porous bodies prepared above are therefore able to remain intact at higher temperatures but will dissolve or disperse at lower temperatures. Samples (100 mg) of the products of examples 18a, 18b and 18c were stirred with water at 65° C. and the solution allowed to cool. The temperature at which the bodies dissolved and the dye was released were:—Example 18a 58° C., Example 18b 57° C. and Example 18c 52° C.

### EXAMPLE 19

An experiment was conducted in order to produce highly porous, rapidly dissolving water-soluble porous bodies in which the polymeric material is poly(2-N,N-dimethylaminoethylmethacrylate) [PDEAEMA]. These bodies were prepared by freezing oil-in-water emulsion in liquid nitrogen. The emulsion comprised an aqueous continuous phase containing PDEAEMA and a discontinuous phase comprising cyclohexane. Hybrane (ex DSM) was used as the surfactant.

2-(Diethylamino)ethyl methacrylate (10 g, 0.054 mol) and 2,2′-azobisisobutyronitrile (0.1 g, 0.61 mmol) were dissolved in dry tetrahydrofuran (100 ml). Dissolved oxygen in the solution was removed by bubbling nitrogen through the solution for 30 minutes. The reaction mixture was heated to 60° C. under a nitrogen atmosphere for 24 hours and then cooled to room temperature, concentrated in vacuo and the residue was dripped into cold acetonitrile in order to precipitate the polymer. The polymer was filtered off and dried overnight under vacuum to give poly(2-N,N-dimethylaminoethylmethacrylate) PDEAEMA as a colourless sticky solid.

A 10% acidified aqueous solution of PDEAEMA was prepared by dissolving the PDEAEMA in deionised water and acidifying with 2M hydrochloric acid. A sample of the solution (4 ml) was stirred with a type RW11 Basic IKA paddle stirrer, and hybrane (0.5 g ex DSM) was added followed by cyclohexane (12 ml) to form an emulsion having 75% v/v of discontinuous phase

### EXAMPLE 19a

The trigger spray airbrush. The frozen emulsion was placed in a freeze-drier overnight to give porous bodies in the form of a powder.

### EXAMPLE 19b

The above emulsion was placed in a beaker which was placed in liquid nitrogen to freeze the emulsion. The frozen emulsion in the beaker was placed in a freeze drier overnight to give a porous moulded body shaped as the inside of the beaker.

### EXAMPLE 19c

A beaker was placed in a thermostatic vessel and liquid nitrogen was placed in both the beaker and the vessel. The emulsion prepared above was added dropwise from a needle to the liquid nitrogen in the beaker using a A-99 FZ Razel syringe pump. The beaker was placed in a freeze drier overnight to give spherical beads.

PDEAEMA is insoluble in water at high pH but becomes soluble as the pH drops. The porous bodies prepared above are therefore able to remain intact at higher pH but will dissolve or disperse at lower pH. Samples (100 mg) of the products of examples 15a, 145 and 15c were stirred with 1 M aqueous sodium hydroxide solution at 20° C. and the solution was acidified with concentrated hydrochloric acid. The pH at which the bodies dissolved wqas around 2 for the products of Example 19a, Example 19b and Example 19c.

### EXAMPLE 20

The powders of Example 5c were tested to determine the deposition of the fluorescer, 2,5-bis(2-benzoxazolyl)thiophene, onto cotton and nylon fabric.

Deposition of fluorescer from the powder was carried out on 10 cm squares of cotton and nylon. A blank (Sample A) was carried out where the cloth was washed with deionised water (18 ml) only, and a comparison (Sample B) was washed with the fluorescer (0.36 mg) in deionised water (18 ml). The powder (3.58 mg) was dissolved into deionised water (18 ml) to give the same amount of Fluorescer as was contained within the powder (Sample C). The washing was carried out for 45 minutes in each case, the cloths were removed, rinsed with deionised water and allowed to dry in air.

Ganz Whiteness measurements were carried out on each sample using a Hunterlab Ultrascan XE Spectrophotometer which measures the reflectance of a sample over a wavelength range of 360 nm to 750 nm at 10 nm intervals. Ganz Whiteness measurements are carried out using calibrated UV source. A fluorescent white tile of known Ganz Whiteness was used to calibrate the UV content of the incident light source during measurement. The Ganz Whiteness Index measures perceived whiteness along a blue-yellow axis rather than neutral white, taking into account the human preference for blueish shades of white. The greater the value of Ganz Whiteness the whiter (or more blueish white) the material—100 units being that of a ‘White tile’. The results obtained are given in Table 11 below

TABLE 11

| Material and formulation | Ganz Whiteness Index |
|---|---|
| Cotton - pre-wash | 80.22 |
| Cotton - Sample A | 84.02 |
| Cotton - Sample B | 91.18 |
| Cotton - Sample C | 114.91 |
| Nylon - pre-wash | 75.51 |
| Nylon - Sample A | 78.53 |
| Nylon - Sample B | 86.91 |
| Nylon - Sample C | 98.36 |

The higher Ganz Whiteness values obtained with the powder of the present invention indicate that the fluorescence efficiency of the fluorescer on the fabric is much higher than when the fluorescer is used in water alone

### EXAMPLE 21

In a similar manner to that described in Example 20, the moulded bodies of Example 14e (Sample D) were tested to determine the deposition of 2,5-bis(2-benzoxazolyl)thiophene onto cotton and nylon fabric. The results obtained are given in Table 12 below

TABLE 12

| Material and formulation | Ganz Whiteness Index |
|---|---|
| Cotton - pre-wash | 80.22 |
| Cotton - Sample A | 84.02 |
| Cotton - Sample B | 91.18 |
| Cotton - Sample D | 113.87 |
| Nylon - pre-wash | 75.51 |
| Nylon - Sample A | 78.53 |
| Nylon - Sample B | 86.91 |
| Nylon - Sample D | 90.92 |

The higher Ganz Whiteness values obtained with the moulded body of the present invention indicate that the fluorescence efficiency of the fluorescer on the fabric is much higher than when the fluorescer is used in water alone

### EXAMPLE 22

In a similar manner to that described in Example 19, the moulded bodies of Example 15b (Sample E) were tested to determine the deposition of 2,5-bis(2-benzoxazolyl)thiophene onto cotton and nylon fabric. The results obtained are given in Table 13 below

TABLE 13

| Material and formulation | Ganz Whiteness Index |
|---|---|
| Cotton - Sample A | 84.56 |
| Cotton - Sample B | 84.6 |
| Cotton - Sample E | 102.61 |
| Nylon - Sample A | 78.61 |
| Nylon - Sample B | 80.14 |
| Nylon - Sample E | 106.63 |

The higher Ganz Whiteness values obtained with the moulded body of the present invention show that the deposition of the fluorescer onto the fabric is much higher than when the fluorescer is used in water alone.

### EXAMPLE 23

The antimicrobial effect of the triclosan containing powder of Example 5c and the moulded body of Example 14d were observed in the following experiment.

Cultures of S. epidermidis and Corynebacterium A were prepared by inoculating the appropriate sterile broths (Brain Heart Infusion broth, Oxoid, UK for S. epidermidis and Coryne broth for Corynebacterium A, (Tryptone soy broth (3.0%), Yeast extract (1.0%), Tween 80 (0.1%)) and incubating with shaking for 24 h at 37° C. Cultures were then centrifuged and resuspended in the appropriate broths to an optical density (OD) at 600 nm of 0.01 (approx. 5.0×10⁶ CFU/ml for S. epidermidis and 1.63×10⁶ CFU/ml for Corynebacterium A).

The higher Ganz Whiteness values obtained with the moulded body of the present invention indicate that the fluorescence efficiency of the fluorescer on the fabric is much higher than when the fluorescer is used in water alone

### EXAMPLE 22

In a similar manner to that described in Example 19, the moulded bodies of Example 15b (Sample E) were tested to determine the deposition of 2,5-bis(2-benzoxazolyl)thiophene onto cotton and nylon fabric. The results obtained are given in Table 13 below

TABLE 13

| Material and formulation | Ganz Whiteness Index |
|---|---|
| Cotton - Sample A | 84.56 |
| Cotton - Sample B | 84.6 |
| Cotton - Sample E | 102.61 |
| Nylon - Sample A | 78.61 |
| Nylon - Sample B | 80.14 |
| Nylon - Sample E | 106.63 |

The higher Ganz Whiteness values obtained with the moulded body of the present invention show that the deposition of the fluorescer onto the fabric is much higher than when the fluorescer is used in water alone.

### EXAMPLE 23

The antimicrobial effect of the triclosan containing powder of Example 5c and the moulded body of Example 14d were observed in the following experiment.

Cultures of S. epidermidis and Corynebacterium A were prepared by inoculating the appropriate sterile broths (Brain Heart Infusion broth, Oxoid, UK for S. epidermidis and Coryne broth for Corynebacterium A, (Tryptone soy broth (3.0%), Yeast extract (1.0%), Tween 80 (0.1%)) and incubating with shaking for 24 h at 37° C. Cultures were then centrifuged and resuspended in the appropriate broths to an optical density (OD) at 600 nm of 0.01 (approx. 5.0×10⁶ CFU/ml for S. epidermidis and 1.63×10⁶ CFU/ml for Corynebacterium A).

Stock solutions of the powder of Example 4c, the moulded body of Example 14d and a 30% solution of triclosan in ethanol were prepared in both sets of broths to a final triclosan concentration of 0.04% (400 ppm). These were filter sterilised through 0.2 μM syringe filter (Whatman, UK). These stocks were serially diluted (doubling dilutions) into a row of wells in 96 well microtitre plates, by adding 85 μl of stock to the first and second wells. To the second well was added 85 μl of appropriate broth. The well contents were thoroughly mixed by charging and discharging the pipette. 85 μl was then removed from the second well into the third well, containing 85 μl of broth and the process repeated until well 10. The final 85 μl were removed and discarded. Wells 11 and 12 were used as controls and contained 85 μl of sterile broth only. Four rows were used per formulation to create four replicate tests. The first 11 wells were inoculated with 85 μl of bacterial suspension and thoroughly mixed, 85 μl of sterile broth was added to well 12 as a negative control. The OD was measured at 600 nm using a plate reader spectrophotometer (Spectramax Plus microplate spectrophotometer, molecular devices, UK) before the plates were sealed and incubated at 37° C. for 24 h. The OD was again measured at 600 nm. Growth inhibition by the biocide was calculated as a percentage of the control (well 11) on the basis of OD for each concentration tested. The data was plotted as biocide concentration vs growth inhibition and the graphs used to estimate the concentration at which the formulation caused a 50% inhibition of growth. This was defined as the MIC for that formulation. The results are given in Table 14

TABLE 14

| | | |
|---|---|---|
| | MIC vs | MIC vs |
| Formulation | S. epidermidis | Corynebacterium A |

| | | | |
|---|---|---|---|
| Triclosan containing | 0.05 | ppm | 30 ppm |
| powder of Example 4c | | | |
| Triclosan containing | 0.05 | ppm | 30 ppm |
| moulded body of | | | |
| Example 14d | | | |
| Triclosan/ethanol | 0.075 | ppm % | 43 ppm |

The lower MIC values seen with the powder and moulded body of the present invention indicate that the activity of the triclosan is improved when it is incorporated into the porous bodies of the present invention.

1) Water dispersible or water soluble porous bodies comprising a three dimensional open-cell lattice containing
(a) 10 to 95% by weight of a water soluble polymeric material and
(b) 5 to 90% by weight of a surfactant,
said porous bodies having an intrusion volume as measured by mercury porosimetry of at least about 3 ml/g
with the proviso that said porous bodies are not spherical beads having an average bead diameter of 0.2 to 5 mm

2) Porous bodies as claimed in claim 1 wherein the bodies are in the form of powders, beads or moulded bodies

3) Porous bodies as claimed in claim 1 or claim 2 wherein the polymeric material is a natural gum, a polysaccharide, a cellulose derivative or a homopolymer or copolymer comprising (co)monomers selected from:—
vinyl alcohol,
acrylic acid,
methacrylic acid
acrylamide,
methacrylamide
acrylamide methylpropane sulphonates
aminoalkylacrylates
aminoalkylmethacrylates
hydroxyethylacrylate
hydroxyethylmethylacrylate
vinyl pyrrolidone
vinyl imidazole
vinyl amines
vinyl pyridine
ethyleneglycol
ethylene oxide
ethyleneimine
styrenesulphonates
ethyleneglycolacrylates
ethyleneglycol methacrylate

4) Porous bodies as claimed in claim 3 wherein the cellulose derivative is selected from xanthan gum, xyloglucan, cellulose acetate, methylcellulose, methyethylcellulose, hydroxyethylcellulose, hydroxyethylmethylcellulose, hydroxypropylcellulose, hydroxypropylmethylcellulose (HPMC), hydroxypropylbutylcellulose, ethylhydroxyethylcellulose, carboxymethylcellulose and its salts, or carboxymethyl-hydroxyethylcellulose and its salts

5) Porous bodies as claimed in any preceding claim wherein the surfactant is non-ionic, anionic, cationic, or zwitterionic

6) Porous bodies as claimed in any preceding claim wherein the surfactant is solid at ambient temperature

7) Porous bodies as claimed in any preceding claim wherein the surfactant is selected from ethoxylated triglycerides; fatty alcohol ethoxylates; alkylphenol ethoxylates; fatty acid ethoxylates; fatty amide ethoxylates; fatty amine ethoxylates; sorbitan alkanoates; ethylated sorbitan alkanoates; alkyl ethoxylates; pluronics; alkyl polyglucosides; stearol ethoxylates; alkyl polyglycosides; alkylether sulfates; alkylether carboxylates; alkylbenzene sulfonates; alkylether phosphates; dialkyl sulfosuccinates; alkyl sulfonates; soaps; alkyl sulfates; alkyl carboxylates; alkyl phosphates; paraffin sulfonates; secondary n-alkane sulfonates; alpha-olefin sulfonates; isethionate sulfonates; fatty amine salts; fatty diamine salts; quaternary ammonium compounds; phosphonium surfactants; sulfonium surfactants; sulfonxonium surfactants; N-alkyl derivatives of amino acids (such as glycine, betaine, aminopropionic acid); imidazoline surfactants; amine oxides; amidobetaines; and mixtures thereof

8) Porous bodies as claimed in any preceding claim wherein the porous polymeric bodies have water soluble or water insoluble materials incorporated into the polymeric lattice

9) Water soluble porous polymeric bodies as claimed in claim 8 wherein the water soluble material is selected from water soluble vitamins; water soluble fluorescers; activated aluminium chlorohydrate; transition metal complexes used as bleaching catalysts; water soluble polymers; diethylenetriaminepentaacetic acid (DTPA); primary and secondary alcohol sulphates containing greater than C8 chain length or mixtures thereof

10) Water soluble porous polymeric bodies as claimed in claim 8 wherein the water insoluble material is selected from antimicrobial agents; antidandruff agent; skin lightening agents; fluorescing agents; antifoams; hair conditioning agents; fabric conditioning agents; skin conditioning agents; dyes; UV protecting agents; bleach or bleach precursors; antioxidants; insecticides; pesticides; herbicides; perfumes or precursors thereto; flavourings or precursors thereto; pharmaceutically active materials; hydrophobic polymeric materials and mixtures thereof.

11) A method for preparing water dispersible or water soluble porous bodies comprising a three dimensional open-cell lattice containing
(a) 10 to 95% by weight of a water soluble polymeric material and
(b) 5 to 90% by weight of a surfactant,
said porous bodies having an intrusion volume as measured by mercury porosimetry (as hereinafter described) of at least about 3 ml/g
with the proviso that said porous bodies are not spherical beads having an average bead diameter of 0.2 to 5 mm
comprising the steps of:
a) providing an intimate mixture of the polymeric material and the surfactant in a liquid medium
b) providing a fluid freezing medium at a temperature effective for rapidly freezing the liquid medium;
c) cooling the liquid medium with the fluid freezing medium at a temperature below the freezing point of the liquid medium for a period effective to rapidly freeze the liquid medium; and
d) freeze-drying the frozen liquid medium to form the porous bodies by removal of the liquid medium by sublimation.

12) A method as claimed in claim 11 wherein the cooling of the liquid medium is accomplished by spraying an atomised emulsion into the fluid freezing medium; by dropping drops of the emulsion into the fluid freezing medium or by pouring the emulsion into a mould and cooling the emulsion in the mould.

13) A method as claimed in claim 11 or 12 wherein the polymeric material is a natural gum, a polysaccharide, a cellulose derivative or a homopolymer or copolymer comprising (co)monomers selected from:—
vinyl alcohol,
acrylic acid,
methacrylic acid
acrylamide,
methacrylamide
acrylamide methylpropane sulphonates
aminoalkylacrylates
aminoalkylmethacrylates
hydroxyethylacrylate
hydroxyethylmethylacrylate
vinyl pyrrolidone
vinyl imidazole
vinyl amines
vinyl pyridine
ethyleneglycol
ethylene oxide
ethyleneimine
styrenesulphonates
ethyleneglycolacrylates
ethyleneglycol methacrylate

14) A method as claimed in any one of claims 11 to 13 wherein the surfactant is non-ionic, anionic, cationic, or zwifterionic

15) A method as claimed in any one of claims 11 to 14 wherein the surfactant is solid at ambient temperature

16) A method as claimed in any one of claims 11 to 15 wherein the surfactant has an HLB value of 8 to 18

17) A method as claimed in any one of claims 11 to 16 wherein the surfactant is selected from ethoxylated triglycerides; fatty alcohol ethoxylates; alkylphenol ethoxylates; fatty acid ethoxylates; fatty amide ethoxylates; fatty amine ethoxylates; sorbitan alkanoates; ethylated sorbitan alkanoates; alkyl ethoxylates; pluronics; alkyl polyglucosides; stearol ethoxylates; alkyl polyglycosides; alkylether sulfates; alkylether carboxylates; alkylbenzene sulfonates; alkylether phosphates; dialkyl sulfosuccinates; alkyl sulfonates; soaps; alkyl sulfates; alkyl carboxylates; alkyl phosphates; paraffin sulfonates; secondary n-alkane sulfonates; alpha-olefin sulfonates; isethionate sulfonates; fatty amine salts; fatty diamine salts; quaternary ammonium compounds; phosphonium surfactants; sulfonium surfactants; sulfonxonium surfactants; N-alkyl derivatives of amino acids (such as glycine, betaine, aminopropionic acid); imidazoline surfactants; amine oxides; amidobetaines; and mixtures thereof

18) A method as claimed in claim 11 wherein the intimate mixture is an oil-in-water emulsion

19) A method as claimed in claim 18 wherein the discontinuous phase of the emulsion comprises 10 to 95% by volume of the emulsion

20) A method as claimed in claim 18 wherein the discontinuous phase of the emulsion comprises 20 to 60% by volume of the emulsion

21) A method as claimed in claim 18 wherein the discontinuous phase of the emulsion is selected from alkanes; cyclic hydrocarbons; halogenated alkanes; esters; ketones; ethers; volatile cyclic silicones and mixtures thereof

22) Solutions or dispersions comprising water soluble polymeric materials and surfactant formed by exposing the porous bodies of any one of claims 1 to 10 to an aqueous medium.

23) Solutions or dispersions comprising water soluble polymeric materials, surfactant and a hydrophobic material formed by exposing the porous bodies of claim 8 having the hydrophobic material contained therein to an aqueous medium.
